(19) United States
(12) Patent Application Publication
(10) Pub. No.: US 2013/0209702 A1
(43) Pub. Date: Aug. 15, 2013

(54) Method and adhesive applicator for the contactless application of a multiplicity of discrete spots of adhesive, distributed over a surface area, permanently to a substrate

(71) Applicant: Josef Rothen, Solingen (DE)

(72) Inventor: Josef Rothen, Solingen (DE)

(73) Assignee: RWR PATENTVERWALTUNG GBR, Solingen (DE)

(21) Appl. No.: 13/821,372

(22) PCT Filed: Sep. 7, 2011
(86) PCT No.: PCT/EP2011/004502

§ 371 Date: Apr. 19, 2013

(30) Foreign Application Priority Data
Sep. 7, 2010 (DE) 20 2010 012 278.3

(51) Int. Cl. B05D 5/10; B05C 1/00; B05D 3/14

(52) U.S. Cl. CPC B05D 5/10; B05D 3/14; B05C 1/00
USPC 427/545; 427/207.1; 118/258

(57) ABSTRACT

In a method for applying a multiplicity of discrete spots of adhesive, distributed over a surface area, permanently to a substrate (3), reduced formation of threads of adhesive is achieved by a rotating applicator head that bears a pattern of openings around its circumference being moved in a direction of application (11) at a lateral distance from and in relation to the surface of the substrate that is to be permanently provided with the pattern, the adhesive is forced out of the openings (2) in the applicator head in the region of a linear or strip-like spacing gap (0) formed between the substrate and the applicator head to form lenticular blobs (4B), the blobs of adhesive are brought into contact with the substrate in the region of the spacing gap, without the applicator head thereby touching the substrate, and the blobs of adhesive are pulled away from the respective openings while becoming attached to the substrate and forming spots of adhesive (4) on the substrate.

### FIELD OF THE INVENTION

The invention relates to a method and an adhesive application device for the contactless application of a multiplicity of discrete spots of adhesive, distributed over a surface area, in a permanent manner to a substrate, with the features according to the preamble of claim 7. It is accordingly provided with reference to the adhesive application device that a multiplicity of discrete spots of adhesive, distributed over a surface area, is applied contactlessly in a permanent manner to a substrate. The applicator head has means which are distributed on its radial (outer) surface for the transfer of spots of adhesive to a substrate. The substrate is usually flat, in particular web-like, and is guided past the rotating applicator head in a suitable manner.

### TECHNOLOGICAL BACKGROUND

In the application of adhesive to a substrate, such as a filter cloth or a membrane film, it is important in many fields of application to keep as much as possible of the surface of the substrate open, i.e. free of adhesive. For this purpose, it is possible to apply greatly elongated and thus thin adhesive strands or blobs of adhesive to the substrate, and to use therefor a rotating head for the contactless application of adhesive (WO 2007/036338), this forming the basis of the invention.

In this known method, the application pattern can only be adhered to in as far as the contactless centrifugal process allows, namely dependent on the rotational speed of the rotating head, the adhesive pressure prevailing there, the temperature of the adhesive, the ambient temperature, and the type of adhesive. In this context, the ambient temperature remains in most cases a not fully controllable factor, since working in temperature-controlled production facilities is usually too costly.

An application method for patterns of spots of adhesives which is not of the generic type and which is based on the principle of contact is known as bowl technology. In this, the means for the transfer of the spots of adhesive consist of small-caliber “bowls”, i.e. recesses in the surface of the applicator roller, their mostly circular footprint, depth, and bowl shape being freely selectable and produced, for example, by means of etching. The bowls are introduced into the surface of the roller according to required surface density and distribution, following a desired surface pattern. The mode of operation is such that the bowls are filled with adhesive by a supply roller or any other means known from printing technology, and the remaining surface of the applicator roller kept free from adhesive. Thereafter, the bowls filled with adhesive can be brought into surface contact or at least line contact with a substrate or a transfer roller, and the adhesive transferred to either of them, by means of rotating the surface of the applicator roller. In this method, very great attention has to be paid to the surface temperature of the applicator roller and of the adhesive, as otherwise an excessive strand formation will result following the transfer of the spot of adhesive from the roller surface to the substrate. That is to say that the volume of adhesive delivered by an individual bowl cannot be transferred fast enough, and usually also cannot be transferred sufficiently completely, to the substrate, such that an adhesive strand is formed between the bowls on the applicator roller and the spots of adhesive on the substrate. Such adhesive strands tear in an undefined manner, and the cooling of the strand leads to the spot of adhesive on the substrate not having sufficiently uniform contours. In addition, remnants of adhesive can remain in the bowls and gradually build up during operation and cause the applicator roller to require replacing or at least cleaning.

Another method for the application of hot-melt adhesives to a surface by means of contact is known from DE 2125387 A1. The application is carried out by a multiplicity of nozzles in a flat applicator plate, the feed bores of which are opened, once the applicator is flatly pressed onto the substrate, by valve tappets which are needle-like and resiliently project from the plate. This method is suited to the batch-based application of hot-melt adhesive. Once the applicator plate has been withdrawn from the substrate and the valves have been closed again, adhesive strands form between the substrate and the needle-like valve tappets, which strands are severed at varying and not insignificant distances from the substrate by means of a pivotable cutting arm with a heatable cutting blade.

Strand-free application systems are further known, with which also melted thermoplastic coating materials can be transferred from a coating head to a substrate. In this context, a screen-like cylinder, which has a printing pattern, as used in screen printing technology is known, along which a web-like or sheet-like substrate, onto which a printing pattern is to be applied, is guided in physical line contact under pressure from a counter-roller. A longitudinal supply chamber, for coating materials, which is arranged parallel to the applicator roller has a nozzle slot which lies on the inner surface of the perforated cylinder jacket in the region of the contact line of the counter-roller. The coating material is squeezed out of the nozzle slot through the cylinder jacket perforation onto the substrate during physical contact between the cylinder and the substrate. Such transfer methods, which are not of the generic type, are known, for example, from DE 19905317 A1 and DE 4020420 A1. It has proven difficult to transfer as many spots of adhesive as possible and/or spots of adhesive which have the smallest possible surface area to a substrate in this manner.

### PRESENTATION OF THE INVENTION

The invention is based on the problem of improving a method and a device for adhesive application of the generic type for surface patterns of spots of adhesive with a view to eliminating as far as possible strand-like structures of adhesive on the treated substrate. To solve this problem, a method for adhesive application with the features of claim 1 and an adhesive application device with the features of claim 7 are proposed. Accordingly, the method provides that a rotating applicator head, having on its circumference a perforated pattern, is displaced in a direction of application at a lateral (radial) distance from and in relation to the surface of the substrate onto which the pattern is to be permanently applied.

The adhesive is squeezed out of the perforations in the applicator head in the region of a line-shaped or stripe-shaped distance gap, which is formed between the substrate and the applicator head, while forming lenticular blobs. The blobs of adhesive are brought into contact with the substrate in the region of the distance gap, without the applicator head touching the substrate. The blobs of adhesive are pulled away from the respective perforations by adherence to the substrate and by formation of spots of adhesive on the substrate.

With a view to an adhesive application device of the generic type, the invention provides that the transfer means for the (small) volumes of adhesive are a multiplicity of perforations, which form a desired application pattern, in a roller jacket which forms a roller surface of an applicator roller, said perforations being fillable with the adhesive on the inside of the roller jacket. A distance gap or nip between the roller surface and the substrate is provided and dimensioned in such a way that the adhesive can be squeezed out of the perforations in the applicator head in the region of the line-shaped or stripe-shaped distance gap, which is formed between the substrate and the applicator head, while forming lenticular blobs. The blobs of adhesive are brought into contact with the substrate in the region of the distance gap, without the applicator head touching the substrate. The blobs of adhesive can be pulled away from the respective perforations by adherence to the substrate and by formation of spots of adhesive on the substrate.

As a result of the invention, the viscosity of the adhesive and thus its behavior with regard to forming strands is better controllable and controllable in reduced dependence on the ambient temperature. It has been recognized that a temperature differential in the adhesive between the applicator head and the substrate can be utilized. Even highly temperature-sensitive sheet-like or web-like substrates, such as films made from PE, can be permanently provided with a surface pattern consisting of spots of adhesive.

Typical cross sections of openings (perforations) are of the magnitude of between a few mm and a couple of pm, preferably between 2 and 0.01 mm, and particularly preferably between 1 and 0.1 mm. As a rule, perforations which are bored and thus of cylindrical shape will suffice. The cross sections of openings may, however, also be provided with other cross-sectional shapes and may, for instance, also be produced by laser treatment. Elongated adhesive supply chambers, which are arranged approximately parallel to the roller axis and which always supply only a limited number of adhesive transfer means/perforations with adhesive whilst the remaining perforations are kept free of adhesive, may be provided in the interior of the transfer roller. Such a chamber preferably extends along the transfer line between the surface of the applicator roller and the substrate accepting the adhesive. In this way, the tendency to form strands is further diminished. The inner surface of the roller jacket is, on the open exit surface of the chamber for adhesive, led substantially in a sealing manner along the chamber wall surrounding the exit surface, such that a shearing effect is imparted to the adhesive on the entry side of the perforations.

In order to keep the negative consequences of a certain level of strand formation, which usually cannot be entirely prevented even with the device according to the invention, as low as possible, a filament-shaped or blade-shaped adhesive strand separator element can be provided in a location behind the transfer nip as seen in the direction of movement of the substrate. This element is very particularly preferably arranged parallel to the axis of rotation of the applicator head, but may also have a directional component which is parallel to the roller axis in order to fulfill its function. In this way, it is possible to specifically sever any forming adhesive strand at an early point in time after the beginning of its creation. This achieves that the adhesive, which is still of relatively low viscosity, can retract from the point of severance to the main mass of the respective spot of adhesive transferred to the substrate. For this, the surface tension of the drop of adhesive usually suffices. The part of the forming adhesive strand which is located on the other side of the separator element has the possibility, based on the early severance of the adhesive strand and its surface tension and its viscosity, to retract again to the transfer means on the surface of the applicator roller. In the case of transfer means formed by perforations in a roller jacket, the adhesive originating from a part of a strand can be kept sufficiently viscous for it to be further used for the next spot of adhesive in the subsequent transfer step that is within a rotation of the transfer roller of less than 360°. An adhesive strand separator element of this type may also be used successfully together with applicator rollers for adhesive used in the forming of spots of adhesive by means of the bowls described above, as well as in such applications in which products other than adhesives, such as pelletizable plastics, are produced. The aforementioned idea of a solution is thus of inventive significance in its own right.

In order to facilitate a retraction of the severed adhesive strands to their respective originating point, the adhesive strand separator element can be heated to a suitable temperature. It is, in particular, possible to use an electric resistance filament or wire which is kept at the desired temperature by electric heating. In this way, the adhesive strands can be melted through, thus significantly or completely reducing the proportion of mechanical separation. The distance between the adhesive separator element and the nip between transfer roller and substrate may be varied according to the type of application. Preferred nip distances are up to 10 cm, preferably up to 1 cm, and particularly preferably up to 0.1 cm.

The aforementioned components and the claimed components and the components which are described in the exemplary embodiments and deployed according to the invention are not subject to any exceptional requirements in terms of their size, shape, material selections and technical concept, such that the known selection criteria applicable to the field of application may unreservedly apply.

Further details, features and advantages of the subject of the invention arise from the dependent claims and from the following description and the accompanying drawing in which—as an example—an exemplary embodiment of an application device for spots of adhesive is illustrated. Individual features of the claims or of the embodiments also may be combined with other features of other claims and embodiments.

### BRIEF EXPLANATION OF THE FIGURES

In the drawing:

FIG. 1 shows a schematic illustration of the adhesive application device in a view of the face end;

FIG. 2 shows the same device in a lateral view of the applicator roller (view A-A according to FIG. 1);

FIG. 3 shows a cross section through the device along the section according to FIG. 2;

FIG. 4 shows an alternative embodiment of an adhesive application device in a lateral view according to FIG. 2, and

FIG. 5 shows a detailed illustration of the pulling-away of a volume of adhesive from an adhesive applicator head.

### DETAILED DESCRIPTION OF EXEMPLARY EMBODIMENTS

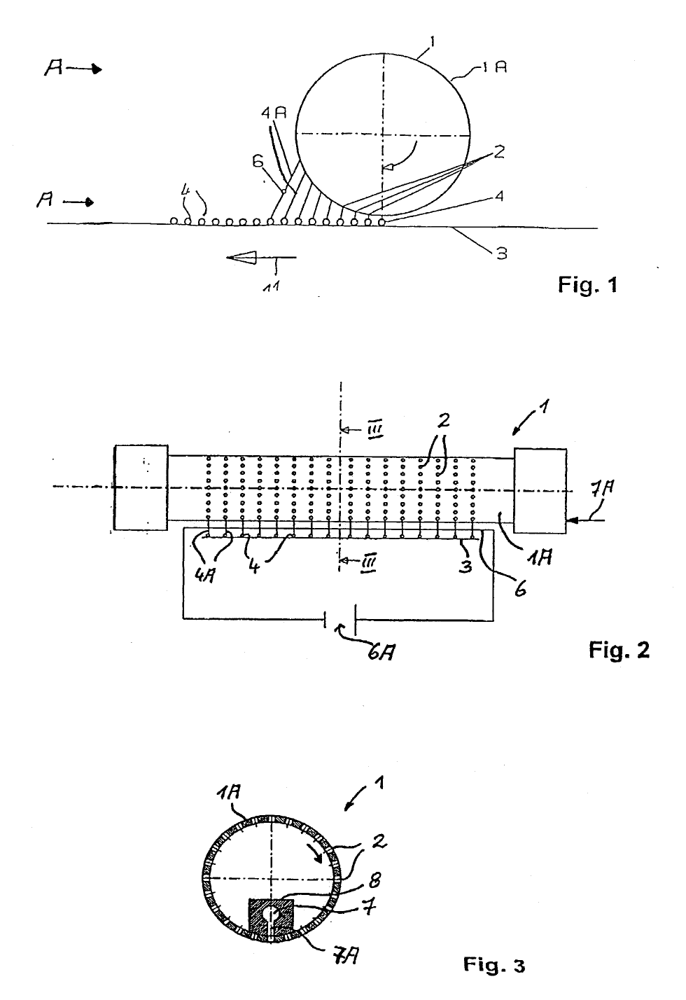

As evident in FIG. 1, an applicator roller 1 is provided which is rotatable about its longitudinal axis and is of circular cylindrical cross section and has a multiplicity of bored perforations 2 which are distributed across its circumference in a roller jacket 1A. A web-like substrate 3 is guided along the roller surface at a small distance below it. The circumferential speed of the roller surface is synchronizable with the linear speed of the substrate and, if required, optimizable with a view to the strand formation. By means of the adhesive which is under suitable pressure and which is fed through the interior of the applicator roller, spots of adhesive 4 are thus formed on the surface of the substrate according to the distribution pattern of the adhesive-transferring perforations on the roller surface. Details are evident in FIG. 5. Adhesive strands 4A can form between the outside muzzles of the perforations 2 on the roller surface and the spots of adhesive formed. These adhesive strands are severed preferably by melting and/or mechanically by an adhesive strand separator element 6, which, for instance, is in the form of a hot filament at a location which is close to the nip between the roller surface and the substrate web. The hot filament is tensioned parallel to the roller axis and across its own length, but at least across the width of the substrate web 3, and supplied with electrical voltage at 6A in order to maintain a required filament temperature and to introduce sufficient heat into the severance point.

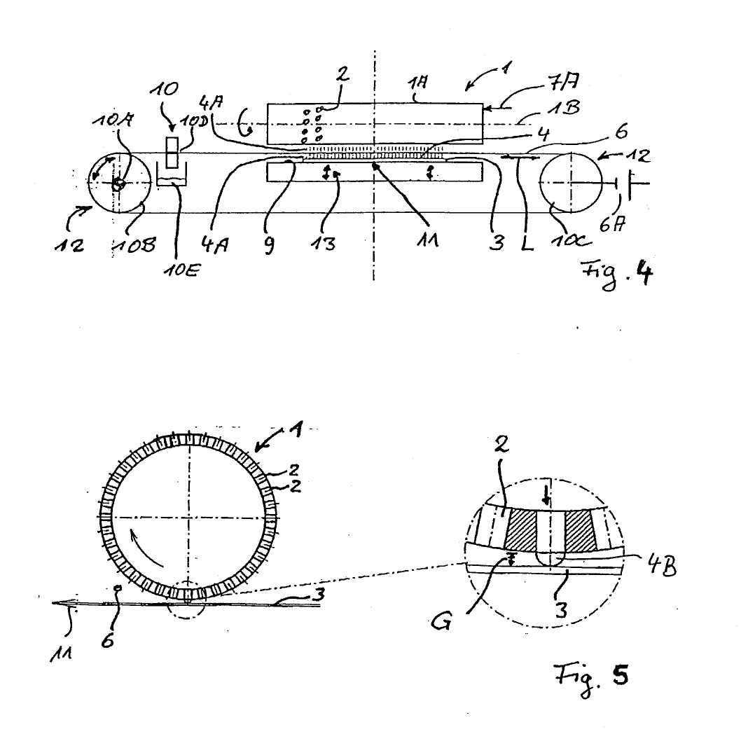

As seen in FIG. 2, the adhesive supply line 7A to the applicator roller 1 can lead to an adhesive chamber 7 in the interior of the roller. There, a stationary adhesive chamber housing 8, as evident in FIG. 3, extends at least along the application width of the applicator roller 1 and lies against the inner surface of the roller jacket 1A in a sealing manner. An adhesive feed slot 7B leads from the elongated adhesive chamber 7 to the inner surface of the roller jacket 1A and thus feed a row of perforations 2 during the time frame in which this row passes the adhesive feed slot. Accordingly, the perforations 2 of this row dispense only during this time frame the amount of adhesive required for one spot of adhesive 4.

Once the adhesive strand 4A, which has thereupon formed between the substrate 3 at the spot of adhesive 4 and the perforations 2, has been severed, one half of the strand retracts to its perforations 2 and the other half of the strand to its spot of adhesive 4.

According to preferred embodiments, the adhesive separator element 6 can be self-cleaning or provided with a cleaning unit 10. A self-cleaning separator element for adhesive can, for instance, evaporate remnants of adhesive strands or chemically decompose them, such that the separator element is cleaned along its active length continuously or at specific time intervals.

FIG. 4 shows an embodiment of the invention with a cleaning unit 10. In this exemplary embodiment, an elongated adhesive separator element in the form of a heatable, in particularly electrically heatable, wire is continuously or intermittently displaced in longitudinal direction in an endless fashion around two deflection rollers 10B, 10C, of which at least one is provided with a rotational drive 10A. As a result, the active zone used for severing the strand is removed from the severing zone and can, for instance, run through a stripper 10D or another cleaning unit which strips the surface of the adhesive separator element 6. Any accumulating remnants of adhesive can thus be collected in a collection element 10E. The heating and temperature control of the adhesive separator element 6 can be implemented by means of one of the deflection rollers 10A and 10B via thermal or electrical contact, as indicated on the left of FIG. 4, through a voltage supply 6A. Instead of a revolving adhesive separator element 6, it is also possible to unwind a suitable filament-shaped element from one spool and to wind it on another or to guide the adhesive separator element 6 in an oscillating manner through the severance points.

In order to be able to interrupt the application in a permanent manner of discrete spots of adhesive distributed over a surface area on the substrate at specific intervals as seen in the direction of application, the distance gap between the applicator head and the substrate can be enlarged while continuing the relative movement of the latter two in the direction of application. In such a way, the lenticular drop of adhesive in the region of the nip cannot achieve the necessary contact with the substrate.

### LIST OF REFERENCE SIGNS

1 Applicator roller

1A Roller jacket

1B Roller axis

2 Perforations

3 Substrate

4 Spots of adhesive

4A Adhesive strands

4B Blob

6 Adhesive strand separator element

6A Electrical voltage supply

7 Adhesive distribution chamber

7A Adhesive supply line

7B Adhesive feed slot

8 Adhesive chamber housing

9 Substrate table

10 Cleaning unit

10A Drive

10B Deflection roller

10C Deflection roller

10D Stripper

10E Collection element

11 Direction of application

12 Moving unit

13 Distance adjustment unit

G Distance gap

L Longitudinal extent

1. A method for the application of a multiplicity of discrete spots of adhesive distributed over a surface area in a permanent manner to a substrate, characterized in that
a rotating applicator head, having on its circumference a perforated pattern, is displaced in a direction of application at a lateral distance from and in relation to the surface of the substrate onto which the pattern is to be permanently applied,
the adhesive is squeezed out of the perforations in the applicator head in the region of a line-shaped or stripe-shaped distance gap, which is formed between the substrate and the applicator head, while forming lenticular blobs,
the blobs of adhesive are brought into contact with the substrate in the region of the distance gap, without the applicator head touching the substrate, and
the blobs of adhesive are pulled away from the respective perforations by adherence to the substrate and by formation of spots of adhesive on the substrate.

2. The method as claimed in claim 1, characterized in that adhesive strands forming behind the transfer nip between the substrate and the rotating applicator head are severed, in particular by melting, at a predetermined distance behind the transfer nip by means of an adhesive strand separator element which extends along the applicator head.

3. The method as claimed in claim 2, characterized in that the severing is carried out by means of electric resistance heating.

4. The method as claimed in claim 2 or 3, characterized in that the elongated adhesive strand separator element is continuously or incrementally moved in a first or in a second direction of its longitudinal extent.

5. The method as claimed in one of claims 2 to 4, characterized in that the adhesive strand separator element is continuously or periodically stripped.

6. The method as claimed in one of claims 1 to 5, characterized in that the application in a permanent manner of discrete spots of adhesive distributed over a surface area on the substrate is interrupted at specific intervals as seen in the direction of application by means of the enlargement of the distance gap between the applicator head and the substrate while continuing the relative movement of the latter two in the direction of application.

7. An adhesive application device for the contactless application of a multiplicity of discrete spots of adhesive distributed over a surface area in a permanent manner to a substrate, comprising a rotatable applicator head which has means, arranged for the distribution of the spots of adhesive, for the transfer of the spots of adhesive onto the substrate which is displaceable in relation to the rotating applicator head, characterized in that
the transfer means are perforations (2) which form an application pattern in a roller jacket (1A) which forms a roller surface of an application roller (1), said perforations being fillable with the adhesive on the inner side of the roller jacket (1A), and that
a distance gap (G) or nip between the roller surface and the substrate is provided and dimensioned in such a way that the adhesive can be squeezed out of the perforations in the applicator head in the region of the line-shaped or stripe-shaped distance gap (G), which is formed between the substrate and the applicator head, while forming lenticular blobs (4B), and the blobs of adhesive (4B) are brought into contact with the substrate in the region of the distance gap, without the applicator head touching the substrate, and
the blobs of adhesive (4B) are pulled away from the respective perforations by adherence to the substrate and by formation of spots of adhesive on the substrate.

8. The adhesive application device as claimed in claim 7, characterized in that the largest cross-sectional extent of the perforations (2), which in particular may be holes of varying geometries or also slots, is between 2 mm and 0.01 mm and particularly preferably between 1 mm and 0.1 mm.

9. The adhesive application device as claimed in claim 7 or 8, characterized in that an adhesive distribution chamber (7) lies against the inner surface of the roller jacket (1A) with the opening rims of the former being sealed.

10. The adhesive application device according to the preamble of claim 7, in particular as claimed in one of claims 7 to 9, characterized in that a filament-shaped or blade-shaped adhesive strand separator element (6) is arranged with a directional component in parallel to the roller axis (1B) in a location behind the transfer nip in the direction of application.

11. The adhesive application device as claimed in claim 10, characterized in that the adhesive strand separator element (6) is located behind the transfer nip at a distance of up to 10 cm, preferably up to 1 cm and particularly preferably up to 0.1 cm.

12. The adhesive application device as claimed in claim 10 or 11, characterized in that the adhesive strand separator element (6) is heatable, in particular adjustable for a heating performance that is sufficient for melting through adhesive strands.

13. The adhesive application device as claimed in one of claims 10 to 12, characterized in that a moving unit (12) is provided for the continuous or incremental movement of the elongated adhesive strand separator element (6) in a first or in a second direction of its longitudinal extent.

14. The adhesive application device as claimed in one of claims 10 to 13, characterized in that a cleaning unit (10) is provided for the continuous or periodic stripping of the adhesive strand separator element.

15. The adhesive application device as claimed in one of claims 7 to 14, characterized in that a distance adjustment unit (13) is provided for the selective enlargement of the distance gap (G) between the applicator head and the substrate at specific intervals as seen in the direction of application (11) while the relative movement between the substrate and the rotating applicator head is continued.

16. The use of an adhesive application device as claimed in one of claims 7 to 15, characterized in that an application roller with a supply of adhesive in its interior and having jacket perforations is used for the manufacture of a permanent surface pattern of adhesive geometrical shapes on a substrate (3).
